(19) United States
(12) Patent Application Publication
(10) Pub. No.: US 2008/0246592 A1
(43) Pub. Date: Oct. 9, 2008

(54) SYSTEM AND METHOD FOR MANAGING CUSTOMER QUEUING

(76) Inventors: Adam Waalkes, Sammamish, WA (US); Gilad Odinak, Bellevue, WA (US)

Correspondence Address: CASCADIA INTELLECTUAL PROPERTY, 500 UNION STREET, SUITE 1005, SEATTLE, WA, 98101, US

(21) Appl. No.: 12/062,373

(22) Filed: Apr. 3, 2008

Related U.S. Application Data
(60) Provisional application No. 60/921,711, filed on Apr. 3, 2007.

(51) Int. Cl. H04M 3/00

(52) U.S. Cl. 340/286.09; 379/265.02

(57) ABSTRACT

A system and method for managing customer queuing is provided. A new request is received from a user. The new request is assigned to a queue. Placed requests waiting in the queue ahead of the new request are counted. The placed requests are compared to a request threshold. An upsell is provided to the user when the placed requests exceed the request threshold. The new request is released from the queue. The new request is satisfied by providing a response to the user.

### CROSS-REFERENCE TO RELATED APPLICATION

This non-provisional patent application claims priority under 35 U.S.C. §119(e) to U.S. Provisional Patent Application, Ser. No. 60/921,711, filed Apr. 3, 2007, the disclosure of which is incorporated by reference.

### FIELD

The present invention relates in general to queue management and, in particular, to a system and method for managing customer queuing.

### BACKGROUND

Drive-throughs have become synonymous with the American fast food experience. In conventional drive-throughs, a customer in a car arrives at a menu kiosk and a sensor signals a drive-through attendant. The attendant greets the customer and takes an order through a two-way speaker. The attendant may “upsell” the customer by offering additional items for purchase with the order. After ordering, the customer proceeds to the attendant's window to pay and receive the order. Finally, the customer departs.

One problem faced in drive-throughs is when to perform an “upsell” without causing delays in order fulfillment. Generally, the times spent waiting and ordering at the kiosk, paying at the cashier's window, and receiving an order, are fairly constant. The waiting times prior to ordering and prior to receiving the order, however, may vary depending upon the number of customers in queue and waiting times increase with the number of customers waiting. Thus, an opportune time to “upsell” is while other cars are waiting ahead of a newly arrived car at the kiosk.

Timing issues aside, “upsells” are generally offered in the attendant's discretion and may be inconsistent or might even fail to happen. For instance, the attendant may fail to consider queue length, or may be distracted, forgetful, reluctant, or even unwilling to “upsell.” An analogous situation also occurs in automated call centers, where callers are placed on hold while waiting for agent assistance. An “upsell,” or other information, could be played while agents are answering other calls. Both, drive-throughs and automated call centers have customers waiting and an opportunity to “upsell” or provide other information.

Therefore, there is a need for providing an opportunistic and consistent approach to presenting flexible “upsells,” and other information, while effectively managing a customer wait queue during order fulfillment, customer service, and similar activities.

### SUMMARY

One embodiment provides an apparatus and method to “upsell” whenever a new car arrives at a kiosk, while other cars are waiting ahead. The apparatus automatically greets the customer and takes their order. With ordering in progress, the apparatus determines whether and how to “upsell” the customer.

A further embodiment provides a system and method to offer an “upsell” or other information while callers are on hold with an automated call center. The content and format of the “upsell” depend upon, for example, waiting queue length, expected wait time, the nature of the question, if known, response completion time, time of day, day of week, season, and other factors.

A further embodiment provides a system and method for managing customer queuing. A new request is received from a user. The new request is assigned to a queue. Placed requests waiting in the queue ahead of the new request are counted. The placed requests are compared to a request threshold. An upsell is provided to the user when the placed requests exceed the request threshold. The new request is released from the queue. The new request is satisfied by providing a response to the user.

A further embodiment provides a system and method for providing customer queuing in an automated call center. A call is received into an automated call center and a request is collected. The call is assigned to a hold queue including held calls. The call is placed on hold based on call capacity determined by the hold queue. A determination to play an upsell during the hold is made. Call factors are collected by analyzing the queue and the call. Content is selected for the upsell based on the call factors. A quantity of the held calls in the hold queue is calculated. A call threshold is applied to the quantity. The upsell comprising the content is played when the quantity exceeds the call threshold. A response is provided to the request.

Still other embodiments of the present invention will become readily apparent to those skilled in the art from the following detailed description, wherein is described embodiments of the invention by way of illustrating the best mode contemplated for carrying out the invention. As will be realized, the invention is capable of other and different embodiments and its several details are capable of modifications in various obvious respects, all without departing from the spirit and the scope of the present invention. The drawings and detailed description are to be regarded as illustrative in nature and not as restrictive.

### BRIEF DESCRIPTION OF THE DRAWINGS

FIG. 1 is a functional block diagram showing, by way of example, a drive-through queue.

FIG. 2 is a process flow diagram showing operation of the drive-through queue of FIG. 1.

FIG. 3 is a functional block diagram showing an automated call center operational environment.

FIG. 4 is process flow diagram showing operation of the automated call center of FIG. 3.

FIG. 5 is a data flow diagram showing a hold queue within the automated call center of FIG. 3.

### DETAILED DESCRIPTION

### Drive-Through Queue

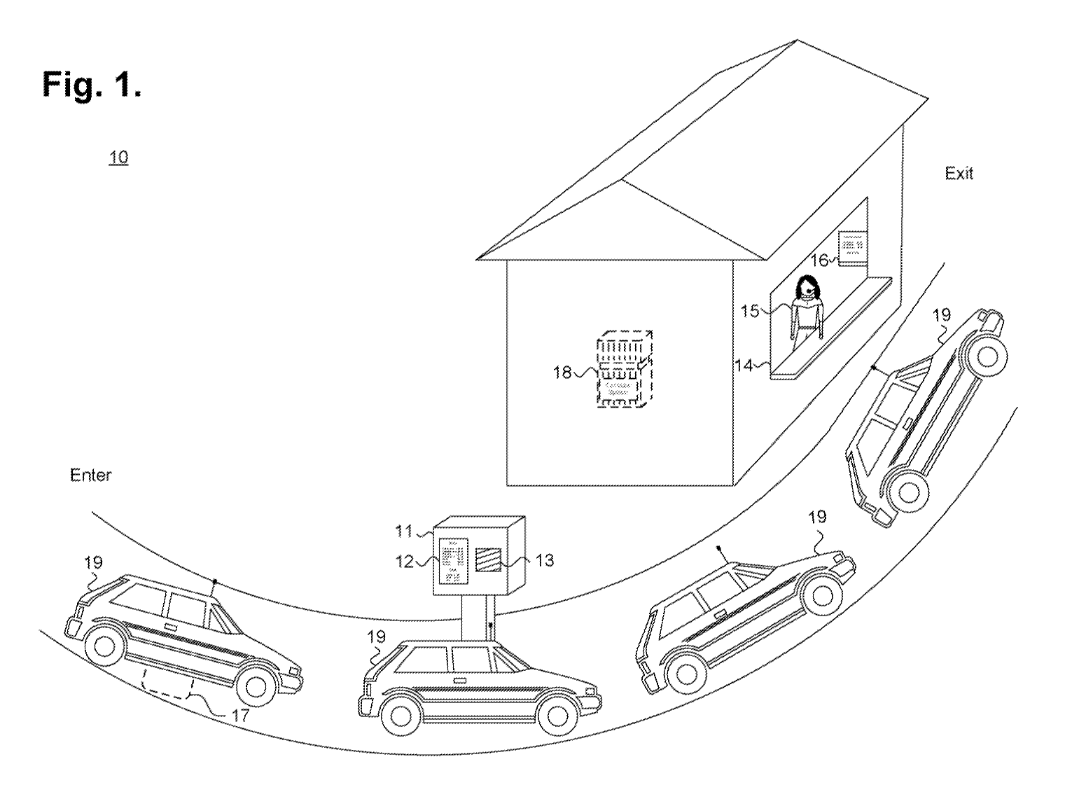

In drive-through restaurants, customers form a single line or a queue to place their orders. FIG. 1 is a functional block diagram showing, by way of example, a drive-through, single line, queue with customers 19. Customers in cars, trucks, and the like may enter the queue to place an order for food, beverages, or other items. Banks and financial institutions also run drive-through windows for offering banking services. Other types of drive-throughs for goods and services are possible.

The drive-through is equipped with an under-pavement sensor 17, a menu kiosk 11 with a menu 12, and a two-way speaker 13. The menu kiosk 11 is interfaced to a computer system 18 located within the restaurant or off-site. The cashier's window 14 includes an order summary screen 16 for a customer attendant 15. Other components in addition to, or in lieu of, the foregoing components are possible, such as multiple sensors and cameras.

The sensor 17 detects each car 19 arriving in the drive-through. The sensor 17 is preferably located prior to the menu kiosk 11, such as at the entry of the drive-through, which allows the computer system 18 to track cars in-queue both before and after the menu kiosk 11. A signal is sent to the cashier's station 14 from the menu kiosk 11 upon each car's arrival to alert the customer attendant 15 of a new customer. The computer system 18 takes the customer's order and sends the order to the customer attendant 15 for payment and fulfillment. Between the time that the customer completes his order and the point at which the order is sent to the customer, the computer system 18 evaluates the drive-through queue and determines whether and how to “upsell” the customer. If the computer system 18 determines that providing an “upsell” is appropriate, the customer listens to an “upsell” or other information while still waiting at the menu kiosk 11. The customer 19 then drives forward to the cashier's window 14 to receive the order. The order may be displayed, and reviewed by the customer 19, on the order summary screen 16. Next, the customer 19 exits after paying and receiving the orders. The system repeats the process with the next customer 19.

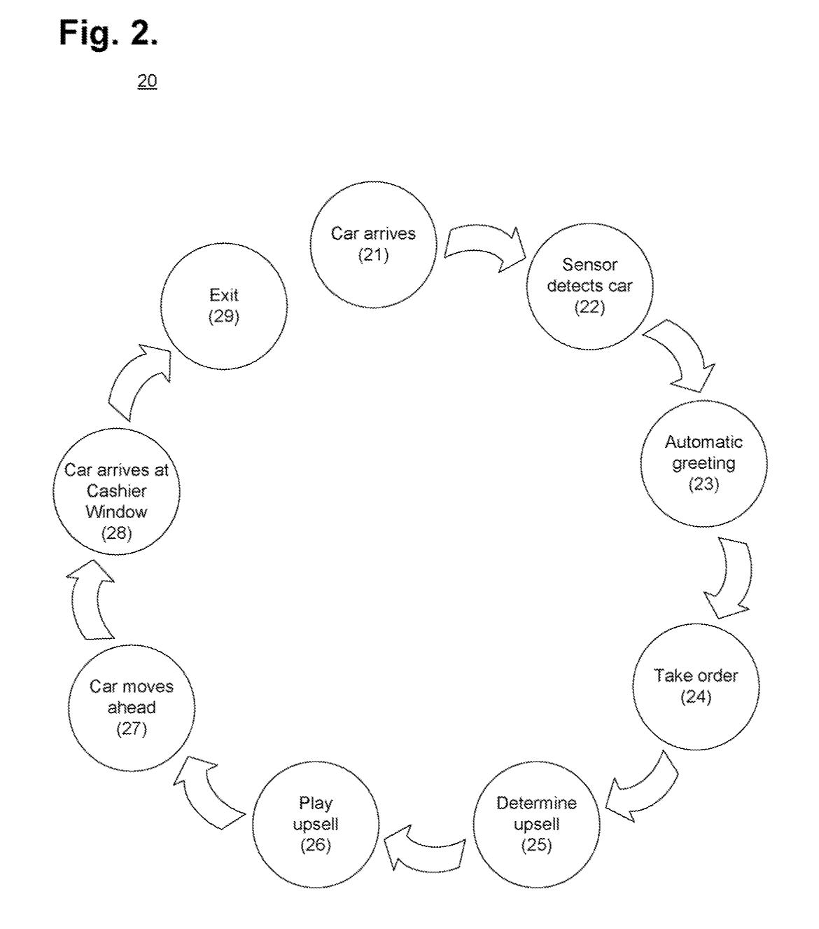

FIG. 2 is a process flow diagram showing operation of the drive-through queue of FIG. 1. As a customer arrives (operation 21) at the menu kiosk 11 of the drive-through, the sensor 17 detects the customer's presence (operation 22). The computer system 18 greets the customer 19 (operation 23) and takes the order (operation 24). At this stage, depending upon queue length, the computer systems 18 may “upsell” or offer additional items for sale, or provide other information (operation 25). An upsell may he a function of various factors, such as queue length, expected waiting time, number of people waiting ahead of the customer, items ordered, order fulfillment time, time of day, day of week, season, holiday, and attendant experience. Other factors are possible.

In one embodiment, a preset threshold value for, for example, queue length is specified for “upsell” determinations. When the number of waiting customers is less than the threshold value, the system skips the “upsell.” When the number of waiting customers reaches or exceeds the threshold value, the system determines the margin of deviation from the threshold value and plays an “upsell” (operation 26) as a function of that margin.

In a further embodiment, a suggestive “upsell” is used (operations 25 and 26). The customer hears a prompt: “Customers who have purchased (name item) have also purchased (name item).” When the waiting queue is long, a long and verbose “upsell” is used. The “upsell” may also be designed to capture the customer's attention. The customer may hear, for example, “Currently, there are (number inserted) customers in line ahead of you. Your estimated waiting time is now (number/time inserted). Customers, who purchased (name item) have also purchased (name item). Our today's most popular item is (name item). May we also interest you in (name item)?” Other factors may be considered in determining “upsell” content. In addition, values other than, or in addition to, queue length maybe considered, as described, in commonly-assigned U.S. Provisional Patent Application, Ser. No. 60/904,296, filed Feb. 28, 2007, abandoned; and U.S. patent application, Ser. No. 12/039,558, filed Feb. 28, 2008, pending; the disclosures of which are incorporated by reference.

In a further embodiment, the “upsell's” content and delivery are a function of one or more parameters and can be played slower or faster depending upon the situation. Where a human attendant may fail to consider various parameters, such as the queue length, expected wait time, the nature of the order, or may be distracted, forgetful, reluctant, or even unwilling to “upsell,” the computer system 18 ensures a flexible and consistent “upsell” determination. Once ordering and “upselling” are finalized, the customer 19 drives forward (operation 27) to arrive at the cashier's window (operation 28). At the cashier's window 14, the payment and order are exchanged. Sometimes, the payment is made at one window and the order is picked up at another window. The customer then exits (operation 29).

### Automated Call Center

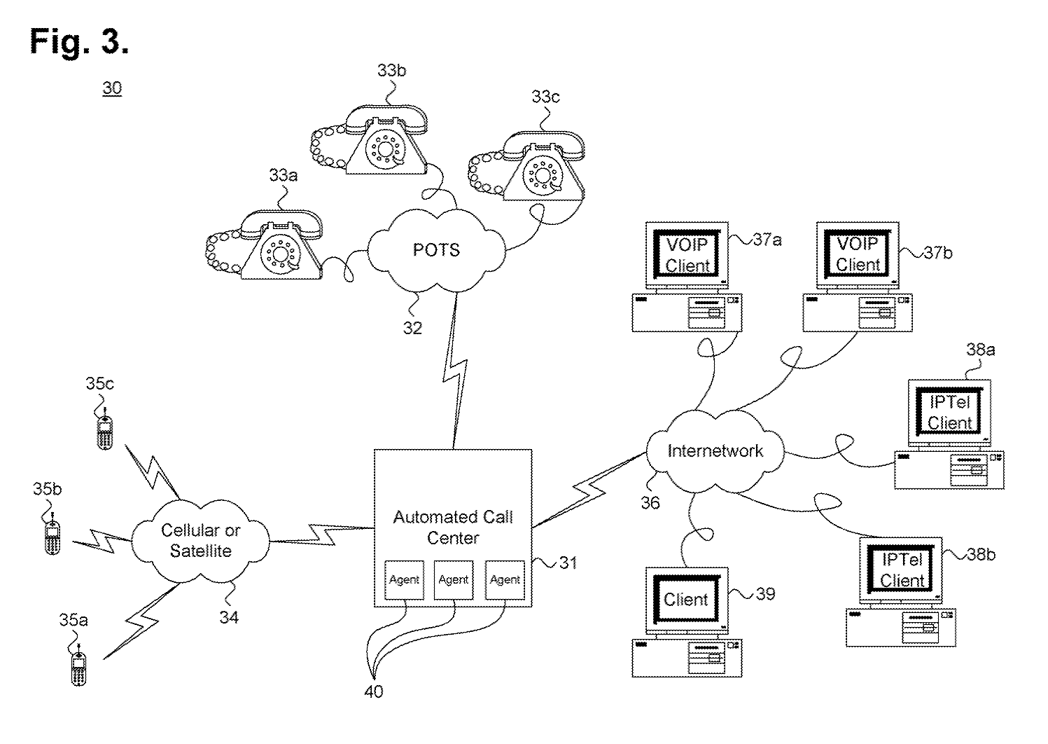

Automated call centers, like drive-throughs, have to address customer-waiting times. Automated call center systems use interactive voice response under programmed control to guide callers through a machine-generated dialogue. Frequently, call centers provide customer support and problem resolution, as well as order fulfillment. FIG. 3 is a functional block diagram showing an automated call center operational environment 30. Callers call into an automated call center 31, generally through telephonic means, such as conventional telephone handsets 33a-c over Plain Old Telephone Service (POTS) 32, portable handsets 35a-c via cellular and satellite telephone service 34, VOIP clients 37a-b, and Internet telephony clients 38a-b. Other forms of telephony and voice-based communications are possible.

Callers can also “call” or interface into the automated call center 31 using conventional network clients 39 through an internetwork 36, including the Internet. Calls are handled by live agents operating agent consoles 40, such as described in commonly-assigned U.S. Provisional Patent Applications, Ser. Nos. 60/403,354, filed Aug. 13, 2002, abandoned, and 60/838,074, filed Aug. 15, 2006, abandoned; U.S. Pat. No. 7,292,689, issued Nov. 6, 2007; and U.S. patent application, Ser. No. 11/893,542, filed Aug. 15, 2007, pending, the disclosures of which are incorporated by reference. Other forms of automated call center access are possible.

In one embodiment, the “upsell” is a function of one or more factors within an automated call center environment. Minimally, the delivery of the “upsell” can depend upon queue length. Other parameters taken singularly or in combination may also be involved in deciding whether and how to “upsell.” For example, the “upsell” may depend on the nature of the question, availability of a live agent, time of day, or geographic location. The “upsell” may also be unique to the caller or physical conditions, or generic to a class of callers.

An “upselling” opportunity occurs whenever a caller is on hold while other calls are being processed. As the automated call center 31 manages queuing and collects caller information or questions, a machine-generated response determines and plays an “upsell” or other information. In a further embodiment, the “upsell” may be played during the interaction of the caller with the automatic prompt and during hold times. Callers may be on hold, for instance, while waiting for the next available live agent.

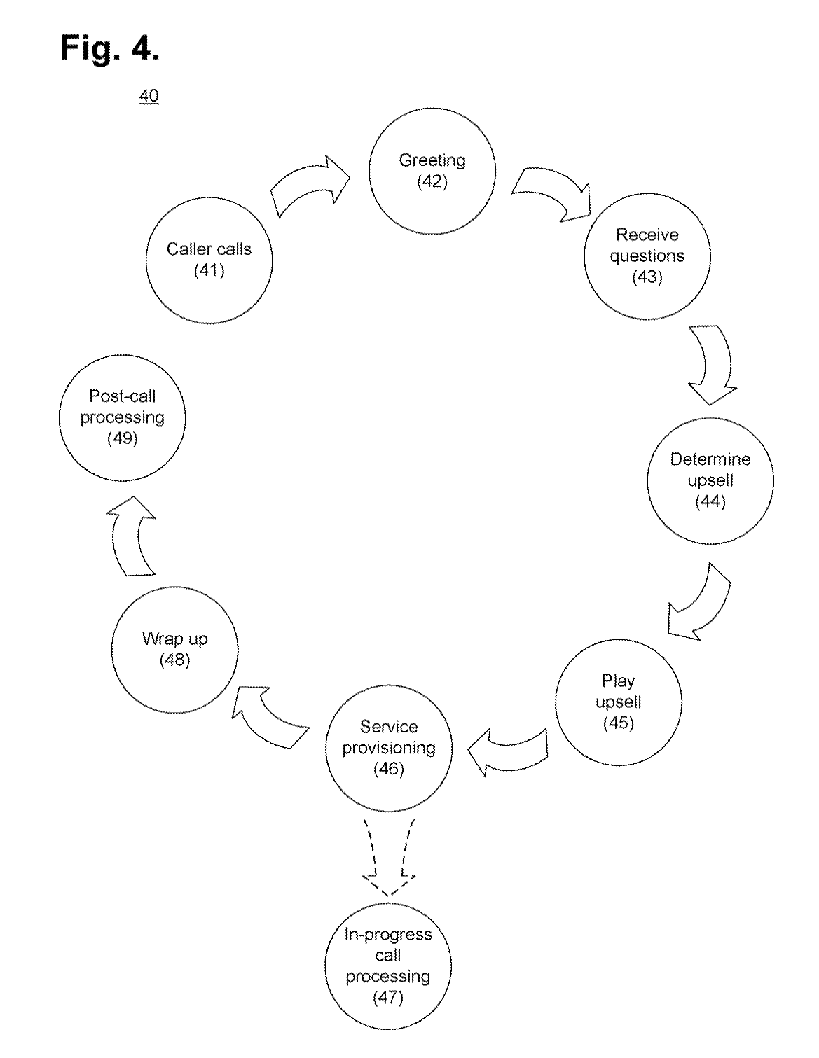

Although the form of call processing required may vary by subject matter and other factors, the same overall sequence of caller-to-agent interchanges loosely applies to most call center scenarios. FIG. 4 is a process flow diagram showing operation of the automated call center 40, as transacted by the automated call center 30 of FIG. 3. Calls are processed through a sequence of phases.

Upon calling into the automated call center 30 (operation 41), each caller receives an initial greeting and informational message (operation 42) that is generated by the automated call center 31. An automated prompt engages the caller in a customer support scenario and processes the caller's questions or requests (operation 43). The automated call center 31 determines both the suitability for and content of an “upsell” (operation 44). The automated call center 31 then plays the “upsell” (operation 45).

In a further embodiment, if several callers are concurrently waiting for an agent, the center 31 may play a longer more verbose “upsell” However, if the caller queue is short, the center 31 utilizes a shorter, less verbose “upsell” or even skips the “upsell” entirely.

As required during the call, service provisioning is provided to the caller (operation 46), as required. The service can include a response to a question or request by the caller, product or service information, confirmation of an order, or account information. Other types of customer service are possible. During the service provisioning, in-progress call processing can be performed (operation 47), including recording, storing, or further analyzing the speech from the call. Other types of in-progress call processing are possible.

In a further embodiment, the “upsell” is played without interrupting the call flow, such as during hold times. The caller can experience hold times from delayed service provisioning, including, for instance, agent unavailability or caller volume capacity limits. Other factors can also delay providing an immediate response to the caller. Throughout the session, the center 31 determines and places the “upsell” within the flow of the call.

Once the service provisioning (operation 46) has been completed, the call ends in a wrap up (operation 48), during which a departing statement can be made. After call wrap up and termination, post-call processing can be performed (operation 49), including analyzing, recording, or storing the speech from the call. Other types of post-call processing are possible. The process flow 40 is repeated for each call received into the call center.

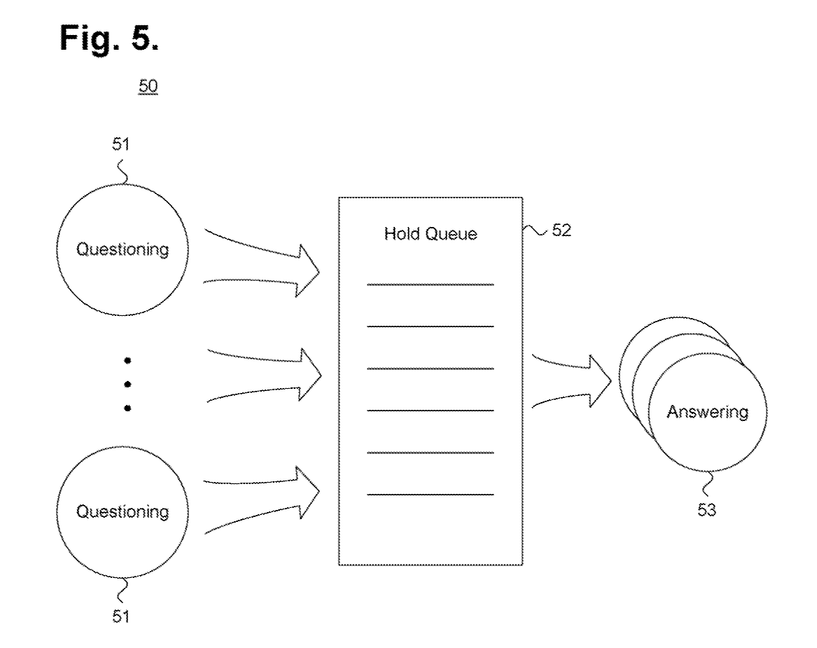

In a further embodiment, a pre-set threshold value, representing one or more parameters, for example, queue length or number of questions, is used. When the system load is less than the threshold value, the system skips the “upsell.” FIG. 5 is a data flow diagram showing a hold queue 52 within an automated call center. New questions 51 are stored in a hold queue 52 for answering 53. When the number of questions in the hold queue 52 reaches or exceeds the threshold value, the caller hears an automated prompt play an “upsell.” For example, the prompt may play: “Eight callers are ahead of you. Callers who have purchased (name item) have also purchased (name item).”

In a further embodiment, the order in which information is gathered from the user to assist with problem resolution and “upsell” determination can be dynamically evaluated and controlled, such as further described in commonly-assigned U.S. Provisional Patent Application, Ser. No. 60/838,101, filed Aug. 15, 2006, abandoned; and U.S. patent application, Ser. No. 11/893,552, filed Aug. 15, 2007, pending, the disclosures of which are incorporated by reference.

In a further embodiment, an attendant can provide an upsell to a customer when there is no customer wait queue or when the customer wait queue is short. The upsell can be provided during an interaction between the attendant and the customer. The attendant can include a call agent, a sales attendant at a drive-through restaurant, or a financial attendant at a financial institution. Other types of attendants are possible.

While the invention has been particularly shown and described as referenced to the embodiments thereof, those skilled in the art will understand that the foregoing and other changes in form and detail may be made therein without departing from the spirit and scope of the invention.

What is claimed is:

1. A system for managing customer queuing, comprising;
a request module configured to receive a new request from a user and further configured to assign the new request to a queue;
a threshold module configured to count placed requests waiting in the queue ahead of the new request and further configured to compare the placed requests to a request threshold;
an upsell module configured to provide an upsell to the user when the placed requests exceed the request threshold;
a release module configured to release the new request from the queue; and
a response module configured to satisfy the new request by providing a response to the user.

2. A system according to claim 1, further comprising:
a content module configured to select content of the upsell based on factors comprising one or more of queue length, the request, time of day, day of week, season, and holiday factors.

3. A system according to claim 1, further comprising:
a duration module configured to determine a duration of the upsell based on factors comprising one or more of queue length, expected wait time, the request, completion of the response, time of day, day of week, season, and holiday factors.

4. A system according to claim 1, further comprising:
a delivery module configured to deliver the upsell to the user through one of an automated call center, a drive-through restaurant, and a drive-through financial institution.

5. A system according to claim 1, wherein the upsell is at least one of unique to the user and generic to a class of users.

6. A system according to claim 1, further comprising:
a playback module configured to play the upsell to the user during one of an interaction with an attendant and during a wait period.

7. A method for managing customer queuing, comprising:
receiving a new request from a user and assigning the new request to a queue;
counting placed requests waiting in the queue ahead of the new request and comparing the placed requests to a request threshold;
providing an upsell to the user when the placed requests exceed the request threshold;
releasing the new request from the queue; and
satisfying the new request by providing a response to the user.

8. A method according to claim 7, further comprising:
selecting content of the upsell based, on factors comprising one or more of queue length, the request, time of day, day of week, season, and holiday factors.

9. A method according to claim 7, further comprising:
determining a duration of the upsell based on factors comprising one or more of queue length, expected wait time, the request, completion of the response, time of day, day of week, season, and holiday factors.

10. A method according to claim 7, further comprising:
delivering the upsell to the user through one of an automated call center, a drive-through restaurant, and a drive-through financial institution.

11. A method according to claim 7, wherein the upsell is at least one of unique to the user and generic to a class of users.

12. A method according to claim 7, further comprising:
playing the upsell to the user during one of an Interaction with an attendant and during a wait period.

13. A system for providing customer queuing in an automated call center, comprising:
a call module configured to receive a call into an automated call center and further configured to collect a request;
a queue module configured to assign the call to a hold queue comprising held calls and further configured to place the call on hold based on call capacity determined by the hold queue;
an upsell module, comprising:
a call factor module configured to collect call factors through an analysis module configured to analyze the queue and the call and further configured to select content for an upsell based on the call factors;
a threshold module configured to calculate a quantity of the held calls in the hold queue and further configured to apply a call threshold to the quantity; and
a playback module configured to play the upsell comprising the content when the quantity exceeds the call threshold; and
a response module configured to provide a response to the request.

14. A system according to claim 13, further comprising:
a duration, module configured to determine a duration of the upsell based on the call factors, wherein the call factors comprise one or more of queue length, expected wait time, the call, completion of the response, a location of a caller, availability of an agent, time of day, day of week, season, and holiday factors.

15. A system according to claim 13, wherein the upsell is at least one of unique to a caller and generic to a class of callers.

16. A system according to claim 13, wherein the playback module is further configured to provide the upsell during an interaction between a caller of the call and an automated prompt played by the automated call center.

17. A method for providing customer queuing in an automated call center, comprising:
receiving a call into an automated call center and collecting a request;
assigning the call to a hold queue comprising held calls and placing the call on hold based on call capacity determined by the hold queue;
determining whether to play an upsell during the hold, comprising;
collecting call factors by analyzing the queue and the call and selecting content for the upsell based on the call factors;
calculating a quantity of the held calls in the hold queue and applying a call threshold to the quantity; and
playing the upsell comprising the content when the quantity exceeds the call threshold; and
providing a response to the request.

18. A method according to claim 17, further comprising:
determining a duration of the upsell based on the call factors, wherein the call factors comprise one or more of queue length, expected wait time, the call, completion of the response, a location of a caller, availability of an agent, time of day, day of week, season, and holiday factors.

19. A method according to claim 17, wherein the upsell is at least one of unique to a caller and generic to a class of callers.

20. A method according to claim 17, further comprising:
providing the upsell during an interaction between a caller of the call and an automated prompt played by the automated call center.
